(19) United States
(12) Patent Application Publication
(10) Pub. No.: US 2026/0030670 A1
(43) Pub. Date: Jan. 29, 2026

(54) SYSTEM AND METHOD FOR DETERMINING ABILITY-TO-REPAY OBLIGATION

(71) Applicant: Formfree Holdings Corporation, Johns Creek, GA (US)

(72) Inventors: Michael Covington, Johns Creek, GA (US); Brian Francis, Johns Creek, GA (US); Brent A. Chandler, Johns Creek, GA (US); Frank Sundstedt, Johns Creek, GA (US); Lisa Lipani, Johns Creek, GA (US)

(73) Assignee: Formfree Holdings Corporation, Johns Creek, GA (US)

(21) Appl. No.: 18/998,455

(22) PCT Filed: Jul. 25, 2023
(86) PCT No.: PCT/US2023/070973

§ 371 Date: Jan. 24, 2025

Related U.S. Application Data
(60) Provisional application No. 63/369,359, filed on Jul. 25, 2022.

(51) Int. Cl. G06Q 40/03

(52) U.S. Cl. CPC G06Q 40/033

(57) ABSTRACT

A system for determining an ability-to-pay an obligation is provided. The system may be configured to electronically receive a query for a transaction between a borrower and a lender. The system may be configured to receive a plurality of data associated with the borrower, and may classify debits within the data as either discretionary or non-discretionary expenses. The system may be configured to adjust the discretionary expenses by an amount based on at least one type associated with the discretionary expenses to generate adjusted discretionary expenses. Using the adjusted discretionary expenses and credits within the data, the system may be configured to compute an ability-to-pay score for the borrower. The system may generate a report including the ability-to-pay score for the borrower and may transmit the report to the requester that issued the query.

### CROSS REFERENCE TO RELATED APPLICATIONS

The present application claims priority to and is a § 371 national phase application of PCT/US23/70973, filed on Jul. 25, 2023, and which claims priority to and the benefit of U.S. Provisional Patent Application No. 63/369,359, filed on Jul. 25, 2022, the entireties of which are hereby incorporated by reference.

### TECHNICAL FIELD

At least some embodiments of the present disclosure relate to evaluating credit worthiness and ability-to-repay analysis, and more particularly, but not limited to, a system and accompanying method for determining ability-to-repay obligation.

### BACKGROUND

Ability-to-repay or ATR is a term used in financial lending to assess an individual's or a borrower's capacity to repay a loan. It refers to the borrower's financial stability, income level, and overall ability to meet the required loan payments over the agreed-upon term. The ability to repay is a critical factor in the lending process as it helps lenders gauge the risk associated with the borrower and make informed decisions regarding loan approval, loan amount, and interest rates. Borrowers with a strong ability to repay are generally more likely to secure loans on favorable terms.

Financial parties typically evaluate several factors to determine a borrower's ability to repay, including: a borrower's regular income from employment or other sources; a borrower's employment; a borrower's debt-to-income ratio, which compares the borrower's total monthly debt payments to their monthly income; a borrower's credit history, including their credit score and past repayment behavior; a borrower's other financial obligations, such as existing loans, rent or mortgage payments, and recurring expenses; and a borrower's assets and collateral.

These factors are usually analyzed in a static environment and are less than optimal ways to assess one's ability to repay debts and obligations. Such rules and analysis cause creditors to make or deny a loan based on the source of income and expenses, which is independent on whether the income or expense will not continue. Traditionally, ATR scores are given to people who always pay on time, have limited credit card debt and no negative collections activity, judgments, or previous bankruptcy filings; those people lose the most points for missing payments, receiving collection items or filing bankruptcy. As a result, static ATR analysis does to provide true measure of one's ability to repay a loan or obligations in periods factors are dynamic or changing.

Accordingly, improved cash flow analysis and modeling techniques may be provided to enhance determination of ability-to-repay obligation. Additionally, systems and methods may be provided to enhance the determination of the creditworthiness of borrowers and identify borrowers that are desired for loans or other obligation instruments.

### SUMMARY

In certain embodiments, a method for determining an ability-to-pay score to evaluate creditworthiness is provided in the present disclosure. In certain embodiments, the method may include electronically receiving a query for a financial transaction between a borrower and a lender, wherein the financial transaction is a loan application. In certain embodiments, the method may include aggregating a plurality of financial records, wherein the financial records are connected with the borrower, and the financial records include debits and credits. In certain embodiments, the method may include classifying the debits into discretionary and non-discretionary expenses. In certain embodiments, the method may include scoring, by utilizing the instructions from the memory that are executed by the processor, the cash flow of the borrower based on the debits and credits, wherein the debits associated with discretionary expenses are given a discount value.

In certain embodiments, another method for determining an ability-to-pay score to evaluate creditworthiness is provided in the present disclosure. The method may include electronically receiving a query for a transaction between a borrower and a lender. Additionally, the method may include receiving a plurality of data associated with the borrower, wherein the data includes debits and credits. The method may include classifying the debits as discretionary or non-discretionary expenses. The method may include adjusting the discretionary expenses by an amount based on at least one type associated with the discretionary expenses to generate adjusted discretionary expenses. Furthermore, the method may include computing, based on the adjusted discretionary expenses and the credits, an ability-to-pay score for the borrower. The method may include synthesizing a report comprising the ability-to-pay score for the borrower. Moreover, the method may include transmitting the report to the lender in response to the query.

A system for determining an ability-to-pay score for evaluating creditworthiness is provided. In certain embodiments, the system may include a memory that stores instructions and a processor that executes the instructions to configure the processor to perform various operations. The system may be configured to electronically receive a query for a transaction between a borrower and a lender. The system may be configured to receive a plurality of data associated with the borrower, wherein the data includes debits and credits. The system may be configured to classify the debits as discretionary or non-discretionary expenses. The system may be configured to adjust the discretionary expenses by an amount based on at least one type associated with the discretionary expenses to generate adjusted discretionary expenses. Additionally, the system may be configured to compute, based on the adjusted discretionary expenses and the credits, an ability-to-pay score for the borrower. Furthermore, the system may be configured to generate a report comprising the ability-to-pay score for the borrower. Moreover, the system may be configured to provide the report to the lender in response to the query.

### BRIEF DESCRIPTION OF THE DRAWINGS

The embodiments are illustrated by way of example and not limitation in the figures of the accompanying drawings in which like references indicate similar elements.

FIG. 1 illustrates an exemplary system for determining ability-to-repay obligations according to embodiments of the present disclosure.

FIG. 2 illustrates an exemplary system for determining ability-to-repay obligations that may operate with and/or be included within the system of FIG. 1 according to embodiments of the present disclosure.

FIG. 3 illustrates an exemplary method for determining ability-to-repay obligations according to embodiments of the present disclosure.

FIG. 4 illustrates an exemplary method for computing an ability-to-repay score of the method of FIG. 3 according to embodiments of the present disclosure.

FIG. 5 illustrates a schematic diagram of a machine in the form of a computer system within which a set of instructions, when executed, can cause the machine to facilitate determination of ability-to-repay obligations according to embodiments of the present disclosure.

### DETAILED DESCRIPTION

Specific embodiments include a system having an interactive graphical user interface (GUI) for depicting a score or index that can be dynamically adjusted based upon cash flow projections calculated and forecast by the system 100 in which discretionary items or amounts may be adjusted. In certain embodiments, for example, these items may be income or expenses.

In certain embodiments, a method for evaluating creditworthiness is provided. The method may include electronically receiving a query for a financial transaction between a borrower and a lender, wherein the financial transaction may be, but is not limited to, a loan application; aggregating a plurality of financial records, wherein the financial records are connected with the borrower, and the financial records may include debits and credits; classifying the debits into discretionary and non-discretionary expenses; and scoring the cash flow of the borrower based on the debits and credits, wherein the debits associated with discretionary expenses are given a discount value. In certain embodiments, the aggregation of the records of the plurality of financial transactions can be at or near a time at which a request for the evaluation of the borrower's creditworthiness is received by a verification service. Additionally, in certain embodiments, the aggregation server may aggregate the records of the plurality of financial transactions on a periodic, or a continual basis. Thus, when a request for the evaluation of the borrower's creditworthiness is received by a verification service, the evaluation of the borrower's creditworthiness may be prepared using (at least in part) previously obtained and stored records of at least a portion of the plurality of financial transactions.

In certain embodiments, a method or system executing the same for determining creditworthiness of a person or entity includes the following steps or operations:
using a network-connected income and expense (credit-debit) verification server to connect with a consumer or potential borrower;
requesting borrower's transaction or financial information from the borrower, which includes bank statements, credit card statements, brokerage statements, payroll data, which may come directly from sources such as a payroll provider of the borrower;
receiving borrower's transaction information;
classifying the transactions by income type (e.g., primary income source, seasonal income, sporadic income, etc.) and spending types (e.g., paychecks, groceries, entertainment, student loan payments, etc.);
analyzing or scoring or index borrower ability to repay based on net income and outgoing transactions;
identifying discretionary expenses within the spending types;
identifying expenses within the spending types that are atypical or unusual financial expenses;
assigning weight or seconding discretionary and unusual expenses to obtain a set of residual transactions; and
scoring or determining a borrower's residual income (available income) and income/expense ratio (cash flow index) based on the typical monthly income minus non-discretionary outgo.

The borrower's adjusted residual income and adjusted income/expense ratio can also be calculated. These may be the same except those discretionary expenses are taken to be reduced in proportion to the extent to which they are discretionary, and in proportion to an overall coefficient determined empirically.

In certain embodiments, the analysis or score or index borrower may represent the ability to repay/obtain residual income score based on the residual transaction, which includes the weighting or scoring assigned to the discretionary and unusual expenses. In some examples, the method can determine the discretionary expenses by increasing or decreasing the borrower's current discretionary fixed expenses at a desired rate. For instance, the discretionary fixed expenses can be decreased by 30% or more. In certain embodiments, cuts to the discretionary fixed expenses may be suggested to the user in order to increase the borrowing potential.

In certain embodiments, the residual score may be calculated as a weighted and scaled combination of typical month's adjusted income/expense ratio (predominant) with zero or more of: total income, adjusted available income, and other closely related measures.

In certain embodiments, the residual score can be reported to the customer scaled to achieve an intended median and interquartile range, based on empirical statistics of actual borrowers.

In certain embodiments, the residual scoring can be computed as part of the overall process, e.g., confirmation of employment.

As can be seen, a method for providing an accurate evaluation of a borrower's creditworthiness, accounts for discretionary expense and discretionary income. The authorization request may include a request for a copy of a pay stub of the consumer, a request for information identifying a financial institution receiving a direct deposit of payroll from the payroll provider, a request for financial institution identification and password information to permit the income-verification server to connect to a financial institution account associated with the consumer, and a request for authorization to use the financial institution identification and password information to access the financial institution account.

Creditworthiness may be a determination of an individual's ability to make, willingness to pay for, and track record for debt payments, as indicated by timely payments to past or current financial obligations. A borrower deemed creditworthy is one a lender considers willing, able and responsible enough to make loan payments as agreed until a loan is repaid.

The terms “entity”, “organization”, and “business” can be used interchangeably and can include any entity or group associated with one or more financial accounts. In certain exemplary embodiments, entity, business and organization may be interchangeably used herein to identify a company, a corporation, a sole proprietorship, an association, a non-profit organization, a charitable organization, a learning institution such as a university or school, a hospital, a chamber of commerce, a government agency or organization at the federal, state, or local level, a professional services firm, a partnership, a foundation, or another entity associated with or having one or more financial accounts.

The terms “financial accounts” and “accounts” can be used interchangeably and can include any financial account associated with an entity, its owner(s), its financial manager(s), or its creditor(s). Unless specifically stated differently or from context, in exemplary embodiments, financial accounts may be interchangeably used herein to identify payroll accounts, merchant accounts, credit card accounts, sweep accounts, lines of credit for the entity, personal lines of credit for the entity's owner(s), and personal savings, checking, overdraft, or home equity accounts of the entity's owner(s).

The terms “business owner”, “user”, “customer”, “proprietor”, “manager”, and “bookkeeper” can be used interchangeably and can include any user that manages financial accounts on behalf of an entity. Unless specifically stated differently or from context, in exemplary embodiments, a user may be interchangeably used herein to identify a human user associated with an entity, such as a business owner, accountant, manager, or bookkeeper, or other person responsible for managing the entity's finances; a software application, or a group of users and/or software applications executed by one or more users to manage the entity's financial transactions. Besides a natural person who can manage financial accounts associated with an entity using an online banking user identification (“user ID”), a software application can be used to process and schedule incoming and outgoing transactions for the entity in accordance with a selected cash reserve and in response to unconfirmed cash shortfalls. Accordingly, unless specifically stated, the terms business owner, user, customer, proprietor, manager and bookkeeper as used herein do not necessarily pertain to a human being.

In certain embodiments, the term “discretionary expense” can mean a cost that a business, individual, or household can survive without, if necessary. Discretionary expenses are often defined as nonessential spending. This means a business or household is still able to maintain itself even if all discretionary consumer spending stops. Meals at restaurants and entertainment costs are examples of discretionary expenses. In some examples, discretionary expenses can include vacations and travel expenses, alcohol and tobacco, Restaurants and other entertainment-related expenses, coffee and specialty beverages, hobby and sports-related expenses, and gym memberships.

In certain embodiments, the term “non-discretionary expense” can mean an essential and non-negotiable spending defined within a budget. As it relates to personal budgets, non-discretionary spending refers to spending on expenses necessary for daily existence. In a corporate environment, discretionary expenses are usually costs linked with promoting or boosting a company's standing in the market. Buying the raw materials used to produce goods is usually considered essential. Spending money on employee training programs is not usually considered essential. Examples of these expenses include rent, food, and mortgage payments.

In certain embodiments, the term “vendors” can refer to natural persons or entities who are suppliers, payees, or creditors of a paying entity (i.e., the payor). In embodiments, vendors can be a person or entity a user may have, or desires to have, a financial relationship with. Such parties may include, but are not limited to, billing entities for Cash Out transactions, which include outgoing transactions and expenses for accounts payable of a paying entity. For example, vendors can include, but are not limited to, utility companies, suppliers, mortgage companies, property management firms, landlords/lessors, credit card issuers, lenders, creditors, government agencies (in cases like taxes, fees, or fines) insurers/insurance agents (in the case of insurance premiums), and other parties with an existing financial relationship with the user's entity whereby the entity makes outgoing payments to the vendor.

In certain embodiments, a method for determining an ability-to-pay score to evaluate creditworthiness is provided in the present disclosure. In certain embodiments, the method may include electronically receiving a query for a financial transaction between a borrower and a lender, wherein the financial transaction is a loan application. In certain embodiments, the method may include aggregating a plurality of financial records, wherein the financial records are connected with the borrower, and the financial records include debits and credits. In certain embodiments, the method may include classifying the debits into discretionary and non-discretionary expenses. In certain embodiments, the non-discretionary expenses may include rent payment history, mortgage payment history, utility payment history, or a combination thereof. In certain embodiments, the non-discretionary expenses may include non-discretionary expenses comprise mortgage loan obligations, car loan obligations, school loan obligations, or a combination thereof. In certain embodiments, the non-discretionary expenses may be provided with an undiscounted value or weight. In certain embodiments, the method may include scoring, by utilizing the instructions from the memory that are executed by the processor, the cash flow of the borrower based on the debits and credits, wherein the debits associated with discretionary expenses are given a discount value. In certain embodiments, the cash flow may be based on the non-discretionary expenses.

In certain embodiments, the aggregation of the plurality of financial transaction records may include computer-executable instructions causing the processor to perform one or more of the operations of the method through one or more application programming interfaces (APis) provided by the financial institution computing system.

In certain embodiments, another method for determining an ability-to-pay score to evaluate creditworthiness is provided in the present disclosure. The method may include electronically receiving a query for a transaction between a borrower and a lender. Additionally, the method may include receiving a plurality of data associated with the borrower, wherein the data includes debits and credits. The method may include classifying the debits as discretionary or non-discretionary expenses. The method may include adjusting the discretionary expenses by an amount based on at least one type associated with the discretionary expenses to generate adjusted discretionary expenses. Furthermore, the method may include computing, based on the adjusted discretionary expenses and the credits, an ability-to-pay score for the borrower. The method may include synthesizing a report comprising the ability-to-pay score for the borrower. Moreover, the method may include transmitting the report to the lender in response to the query.

In certain embodiments, the method may include classifying the debits and credits according to at least one debit type and at least one credit type respectively. In certain embodiments, the method may include calculating a total amount of credits for each time period over a timeframe, and calculating a total amount of debits for each time period over the timeframe based on the non-discretionary expenses and the adjusted discretionary expenses. In certain embodiments, the method may include rejecting the total amount of credits for each time period for which information associated with the portion of the total amount of credits is insufficient, is atypical, or a combination thereof, thereby resulting in remaining total amount of credits for each remaining time period. In certain embodiments, the method may include rejecting the total amount of debits for each time period for which information associated with the portion of the total amount of debits is insufficient, is atypical, or a combination thereof, thereby resulting in remaining total amount of debits for each remaining time period.

In certain embodiments, the method may include calculating a mean total income for reach remaining time period based on the remaining total amount of credits for each remaining time period. In certain embodiments, the method may include calculating a mean adjusted residual income for each remaining time period, wherein the mean adjust residual income is calculated based on subtracting the remaining total amount of debits for each remaining time period from the remaining total amount of credits for each remaining time period to result in a residual income for each remaining time period and the averaging the residual income for each remaining time period. In certain embodiments, the method may include calculating a mean adjusted residual income to expense ratio, wherein the mean adjusted residual income to expense ratio is calculated based on dividing the remaining total amount of credits for each remaining time period by the remaining total amount of debits for each remaining time period to result in a residual income to expense ratio for each remaining time period and averaging the residual income to expense ratio for each remaining time period. In certain embodiments, the method may include calculating a threshold score associated with the borrower for each remaining time period. In certain embodiments, the method may include computing the ability-to-pay score based on the mean total income, the mean adjusted residual income, the mean adjusted income to expense ratio, the threshold score, and the offset.

A system for determining an ability-to-pay score for evaluating creditworthiness is provided. In certain embodiments, the system may include a memory that stores instructions and a processor that executes the instructions to configure the processor to perform various operations. The system may be configured to electronically receive a query for a transaction between a borrower and a lender. The system may be configured to receive a plurality of data associated with the borrower, wherein the data includes debits and credits. The system may be configured to classify the debits as discretionary or non-discretionary expenses. The system may be configured to adjust the discretionary expenses by an amount based on at least one type associated with the discretionary expenses to generate adjusted discretionary expenses. Additionally, the system may be configured to compute, based on the adjusted discretionary expenses and the credits, an ability-to-pay score for the borrower. Furthermore, the system may be configured to generate a report comprising the ability-to-pay score for the borrower. Moreover, the system may be configured to provide the report to the lender in response to the query.

In certain embodiments, the system may be configured to calculate a total amount of credits for each time period over a timeframe, and a total amount of debits for each time period over the timeframe based on the non-discretionary expenses and the adjusted discretionary expenses. In certain embodiments, the system may be configured to reject the total amount of credits for each time period for which information associated with the portion of the total amount of credits is insufficient, is atypical, or a combination thereof, thereby resulting in remaining total amount of credits for each remaining time period. In certain embodiments, the system may be configured to reject the total amount of debits for each time period for which information associated with the portion of the total amount of debits is insufficient, is atypical, or a combination thereof, thereby resulting in remaining total amount of debits for each remaining time period. In certain embodiments, the system may be configured to calculate a mean total income for reach remaining time period based on the remaining total amount of credits for each remaining time period. In certain embodiments, the system may be configured to calculate a mean adjusted residual income for each remaining time period, wherein the mean adjust residual income is calculated based on subtracting the remaining total amount of debits for each remaining time period from the remaining total amount of credits for each remaining time period to result in a residual income for each remaining time period and the averaging the residual income for each remaining time period.

In certain embodiments, the system may be configured to calculate a mean adjusted residual income to expense ratio, wherein the mean adjusted residual income to expense ratio is calculated based on dividing the remaining total amount of credits for each remaining time period by the remaining total amount of debits for each remaining time period to result in a residual income to expense ratio for each remaining time period and averaging the residual income to expense ratio for each remaining time period. In certain embodiments, the system may be configured to calculate a threshold score associated with the borrower for each remaining time period. In certain embodiments, the system may be configured to compute the ability-to-pay score based on the mean total income, the mean adjusted residual income, the mean adjusted income to expense ratio, the threshold score and an offset. In certain embodiments, the system may be configured to determine whether the borrower is suitable for the transaction based on the ability-to-pay score. For example, the borrower may be suitable for the transaction if the ability-to-pay score is above a threshold value or within a threshold range of values.

### Exemplary Embodiments of Computer System Implementation

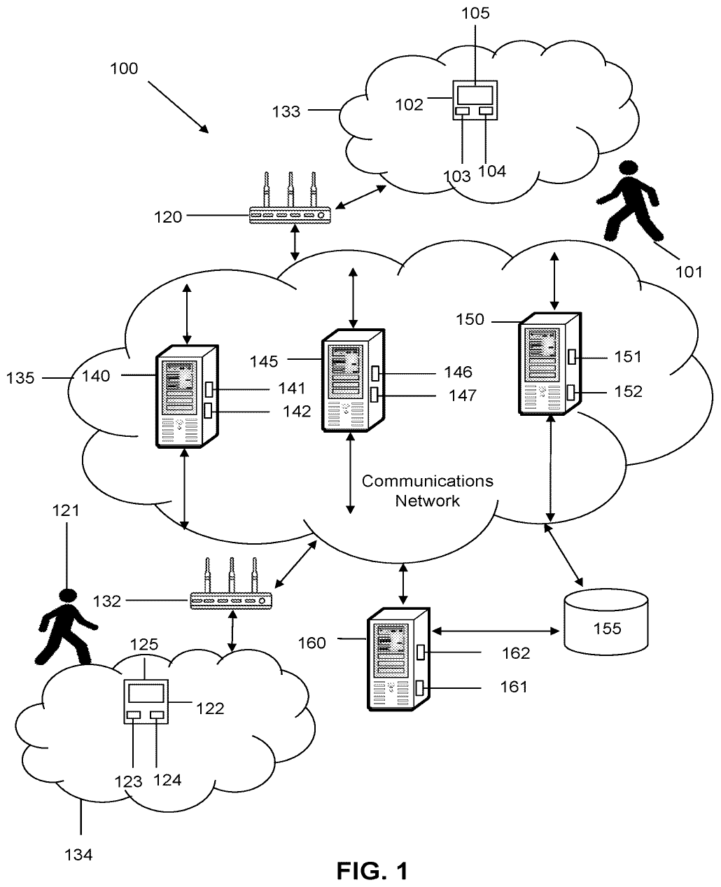

As shown in FIGS. 1-2 and 6, a system 100 for determining ability-to-repay obligation according to embodiments of the present disclosure is provided. Notably, the system 100 may be configured to support, but is not limited to supporting, credit worthiness analysis systems, financial transaction systems, cloud computing systems and services, privacy systems and services, firewall systems and services, data analytics systems and services, data collation and processing systems and services, artificial intelligence services and systems, machine learning services and systems, neural network services, mobile applications and services, content delivery services, satellite services, telephone services, voice-over-internet protocol services (VoIP), software as a service (SaaS) applications, platform as a service (PaaS) applications, gaming applications and services, social media applications and services, operations management applications and services, productivity applications and services, and/or any other computing applications and services. Notably, the system 100 may include a first user 101, who may utilize a first user device 102 to access data, content, and services, or to perform a variety of other tasks and functions. As an example, the first user 101 may utilize first user device 102 to transmit signals to access various online services and content, such as those available on an internet, on other devices, and/or on various computing systems. In certain embodiments, the first user 101 may utilize the first user device 102 to access services and/or content by interacting with software applications that are capable of communicating with service providers and/or content providers. For example, the software applications may be mobile applications or desktop applications that allow a user, such as first user 101 to submit personal information, financial information, and/or other information associated with the user into the application so that the service provider and/or content provider may determine the user's credit worthiness and ability to repay a loan or other obligation. As an example, the service provider may be a banking institution or lender that issues loans and may want to determine, such as based on financial transaction data associated with a user, whether the user is a good candidate for a loan and has a threshold probability of repaying the loan according to the terms of the loan. As another example, the first user device 102 may be utilized to access an application, devices, and/or components of the system 100 that provide any or all of the operative functions of the system 100.

In certain embodiments, the first user 101 may be a person, a robot, a humanoid, a program, a computer, any type of user, or a combination thereof, that may be located in a particular location or environment. In certain embodiments, the first user 101 may be a person that may want to utilize the first user device 102 to conduct various types of activities and/or access content. For example, an activity may include, but is not limited to, accessing digital resources, such as, but not limited to, website content, application content, video content, audio content, haptic content, audiovisual content, virtual reality content, augmented reality content, any type of content, or a combination thereof. In certain embodiments, other activities may include, but are not limited to, accessing various types of applications, such as to perform work, create content, experience content, communicate with other users, transmit content, upload content, download content, or a combination thereof. In certain embodiments, other activities may include interacting with links for accessing and/or interacting with devices, systems, programs, or a combination thereof. In certain embodiments, the first user 101 may be a potential borrower that may be applying for a mortgage or other type of loan, such as from a financial institution, such as a bank or mortgage lender.

In certain embodiments, the first user device 102 may include a memory 103 that includes instructions, and a processor 104 that executes the instructions from the memory 103 to perform the various operations that are performed by the first user device 102. In certain embodiments, the processor 104 may be hardware, software, or a combination thereof. The first user device 102 may also include an interface 105 (e.g., screen, monitor, graphical user interface, etc.) that may enable the first user 101 to interact with various applications executing on the first user device 102 and to interact with the system 100. In certain embodiments, the first user device 102 may be and/or may include a computer, any type of sensor, a laptop, a set-top-box, a tablet device, a phablet, a server, a mobile device, a smartphone, a smart watch, a voice-controlled-personal assistant, a physical monitoring device (e.g., camera, etc.), an internet of things device (IoT), appliances, an autonomous vehicle, and/or any other type of computing device. Illustratively, the first user device 102 is shown as a computer in FIG. 1. In certain embodiments, the first user device 102 may be utilized by the first user 101 to control, access, and/or provide some or all of the operative functionality of the system 100.

In addition to using first user device 102, the first user 101 may also utilize and/or have access to any number of additional user devices. As with first user device 102, the first user 101 may utilize the additional user devices to transmit signals to access various online services and content and/or access functionality provided by an enterprise. The additional user devices may include memories that include instructions, and processors that executes the instructions from the memories to perform the various operations that are performed by the additional user devices. In certain embodiments, the processors of the additional user devices may be hardware, software, or a combination thereof. The additional user devices may also include interfaces that may enable the first user 101 to interact with various applications executing on the additional user devices and to interact with the system 100. In certain embodiments, the first user device 102 and/or the additional user devices may be and/or may include a computer, any type of sensor, a laptop, a set-top-box, a tablet device, a phablet, a server, a mobile device, a smartphone, a smart watch, an autonomous vehicle, and/or any other type of computing device, and/or any combination thereof. Sensors may include, but are not limited to, cameras, motion sensors, acoustic/audio sensors, pressure sensors, temperature sensors, light sensors, any type of sensors, or a combination thereof.

The first user device 102 and/or additional user devices may belong to and/or form a communications network 133. In certain embodiments, the communications network 133 may be a local, mesh, and/or other network that enables and/or facilitates various aspects of the functionality of the system 100. In certain embodiments, the communications network may be formed between the first user device 102 and additional user devices through the use of any type of wireless or other protocol and/or technology. For example, user devices may communicate with one another in the communications network by utilizing any protocol and/or wireless technology, satellite, fiber, or any combination thereof. Notably, the communications network may be configured to communicatively link with and/or communicate with any other network of the system 100 (e.g., communications network 135) and/or outside the system 100.

In certain embodiments, the first user device 102 and additional user devices belonging to the communications network 133 may share and exchange data with each other via the communications network 133. For example, the user devices may share information relating to the various components of the user devices, information associated with images, links, and/or content accessed and/or attempting to be accessed by the first user 101 of the user devices, information identifying the locations of the user devices, information indicating the types of sensors that are contained in and/or on the user devices, information identifying the applications being utilized on the user devices, information identifying how the user devices are being utilized by a user, information identifying user profiles for users of the user devices, information identifying device profiles for the user devices, information identifying the number of devices in the communications network 133, information identifying devices being added to or removed from the communications network 133, any other information, or any combination thereof.

In certain embodiments, the system 100 may include an edge device 120, which the first user 101 may access to gain access to various resources, devices, systems, programs, or a combination thereof, outside the communications network 133. In certain embodiments, the edge device 120 may be or may include, network servers, routers, gateways, switches, media distribution hubs, signal transfer points, service control points, service switching points, firewalls, routers, nodes, computers, proxy device, mobile devices, or any other suitable computing device, or any combination thereof. In certain embodiments, the edge device 120 may connect with any of the devices and/or componentry of the communications network 135. In certain embodiments, the edge device 120 may be provided by and/or be under the control of a service provider, such as an internet, television, telephone, and/or other service provider of the first user 101. In certain embodiments, the edge device 120 may be provided by and/or be under control of a provider. In certain embodiments, the system 100 may operate without the edge device 120 and the first user device 102 may operate as an edge device, such as for communications network 135.

In addition to the first user 101, the system 100 may also include a second user 121. In certain embodiments, the second user 121 may be similar to the first user 101 and may seek to access content, applications, systems, and/or devices. In certain embodiments, the second user device 122 may be utilized by the second user 121 to transmit signals to request various types of resources, content, services, and data provided by and/or accessible by communications network 135 or any other network in the system 100. In further embodiments, the second user 121 may be a robot, a computer, a vehicle (e.g., semi or fully-automated vehicle), a humanoid, an animal, any type of user, or any combination thereof. In certain embodiments, the second user 121 may be another potential borrower that may be seeking to obtain a loan. In certain embodiments, the second user 121 may be an employee of a financial institution that originates loans and may be tasked with reviewing the financial transaction data and/or other data associated with the first user 101 to assist in determining whether the first user 101 is a quality candidate for a loan or other obligation instrument. The second user device 122 may include a memory 123 that includes instructions, and a processor 124 that executes the instructions from the memory 123 to perform the various operations that are performed by the second user device 122. In certain embodiments, the processor 124 may be hardware, software, or a combination thereof. The second user device 122 may also include an interface 125 (e.g., screen, monitor, graphical user interface, etc.) that may enable the first user 101 to interact with various applications executing on the second user device 122 and, in certain embodiments, to interact with the system 100. In certain embodiments, the second user device 122 may be a computer, a laptop, a set-top-box, a tablet device, a phablet, a server, a mobile device, a smartphone, a smart watch, an autonomous vehicle, and/or any other type of computing device. Illustratively, the second user device 122 is shown as a mobile device in FIG. 1. In certain embodiments, the second user device 122 may also include sensors, such as, but are not limited to, cameras, audio sensors, motion sensors, pressure sensors, temperature sensors, light sensors, humidity sensors, any type of sensors, or a combination thereof. In certain embodiments, the second user 121 may also utilize additional user devices as well.

In certain embodiments, the second user device 122 and additional user devices belonging to the communications network 134 may share and exchange data with each other via the communications network 134. For example, the user devices may share information relating to the various components of the user devices, information associated with images, links, and/or content accessed and/or attempting to be accessed by the second user 121 of the user devices, information identifying the locations of the user devices, information indicating the types of sensors that are contained in and/or on the user devices, information identifying the applications being utilized on the user devices, information identifying how the user devices are being utilized by a user, information identifying user profiles for users of the user devices, information identifying device profiles for the user devices, information identifying the number of devices in the communications network 134, information identifying devices being added to or removed from the communications network 134, any other information, or any combination thereof. In certain embodiments, the system 100 may include edge device 132, which may be utilized by the second user device 122 and/or additional user devices to communicate with other networks, such as communications network 135, and/or devices, programs, and/or systems that are external to the communications network 134, such as communications network 133.

In certain embodiments, the user devices described herein may have any number of software functions, applications and/or application services stored and/or accessible thereon. For example, the user devices may include applications for controlling and/or accessing the operative features and functionality of the system 100, applications for controlling and/or accessing any device of the system 100, financial transaction applications, loan origination applications, credit worthiness analysis applications, artificial intelligence and/or machine learning applications, cybersecurity applications, interactive social media applications, biometric applications, cloud-based applications, VoIP applications, other types of phone-based applications, product-ordering applications, business applications, e-commerce applications, media streaming applications, content-based applications, media-editing applications, database applications, gaming applications, internet-based applications, browser applications, mobile applications, service-based applications, productivity applications, video applications, music applications, social media applications, any other type of applications, any types of application services, or a combination thereof. In certain embodiments, the software applications may support the functionality provided by the system 100 and methods described in the present disclosure. In certain embodiments, the software applications and services may include one or more graphical user interfaces so as to enable the first and/or second users 101, 121 to readily interact with the software applications. The software applications and services may also be utilized by the first and/or second users 101, 121 to interact with any device in the system 100, any network in the system 100, or any combination thereof. In certain embodiments, user devices may include associated telephone numbers, device identities, network identifiers (e.g., IP addresses, etc.), and/or any other identifiers to uniquely identify the user devices.

The system 100 may also include a communications network 135. The communications network 135 may include resources (e.g., data, web pages, content, documents, computing resources, applications, and/or any other resources) that may be accessible to the first user 101 and/or second user 121. The communications network 135 of the system 100 may be configured to link any number of the devices in the system 100 to one another. For example, the communications network 135 may be utilized by the second user device 122 to connect with other devices within or outside communications network 135. Additionally, the communications network 135 may be configured to transmit, generate, and receive any information and data traversing the system 100. In certain embodiments, the communications network 135 may include any number of servers, databases, or other componentry. The communications network 135 may also include and be connected to a neural network, a mesh network, a local network, a cloud-computing network, an IMS network, a VoIP network, a security network, a VoLTE network, a wireless network, an Ethernet network, a satellite network, a broadband network, a cellular network, a private network, a cable network, the Internet, an internet protocol network, MPLS network, a content distribution network, any network, or any combination thereof. Illustratively, servers 140, 145, and 150 are shown as being included within communications network 135. In certain embodiments, the communications network 135 may be part of a single autonomous system that is located in a particular geographic region, or be part of multiple autonomous systems that span several geographic regions.

Notably, the functionality of the system 100 may be supported and executed by using any combination of the servers 140, 145, 150, and 160. The servers 140, 145, and 150 may reside in communications network 135, however, in certain embodiments, the servers 140, 145, 150 may reside outside communications network 135. The servers 140, 145, and 150 may provide and serve as a server service that performs the various operations and functions provided by the system 100. In certain embodiments, the server 140 may include a memory 141 that includes instructions, and a processor 142 that executes the instructions from the memory 141 to perform various operations that are performed by the server 140. The processor 142 may be hardware, software, or a combination thereof. Similarly, the server 145 may include a memory 146 that includes instructions, and a processor 147 that executes the instructions from the memory 146 to perform the various operations that are performed by the server 145. Furthermore, the server 150 may include a memory 151 that includes instructions, and a processor 152 that executes the instructions from the memory 151 to perform the various operations that are performed by the server 150. In certain embodiments, the servers 140, 145, 150, and 160 may be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 140, 145, 150 may be communicatively linked to the communications network 135, any network, any device in the system 100, or any combination thereof.

The database 155 of the system 100 may be utilized to store and relay information that traverses the system 100, cache content that traverses the system 100, store data about each of the devices in the system 100 and perform any other typical functions of a database. In certain embodiments, the database 155 may be connected to or reside within the communications network 135, any other network, or a combination thereof. In certain embodiments, the database 155 may serve as a central repository for any information associated with any of the devices and information associated with the system 100. Furthermore, the database 155 may include a processor and memory or may be connected to a processor and memory to perform the various operations associated with the database 155. In certain embodiments, the database 155 may be connected to the servers 140, 145, 150, 160, the first user device 102, a second user device 122, the communications network 133, the communications network 134, the communications network 135, a server 140, a server 145, a server 150, a server 160, edge devices 120, 132, and a database 155, the additional user devices, any devices in the system 100, any process of the system 100, any program of the system 100, any other device, any network, or any combination thereof.

The database 155 may also store information and metadata obtained from the system 100, store metadata and other information associated with the first and second users 101, 121, store profiles for the networks of the system, information identifying the networks of the system 100, store financial transaction data associated with a user (e.g., credits and debits from an account of a user with a banking institution, credit scores, loan history information, credit card purchases and payment history, investment information, any other information, or a combination thereof), store ability-to-pay analyses conducted by the system 100, store assessments of ability-to-pay made and/or received by the system 100, store machine learning models, store training data and/or information utilized to train the machine learning models, store algorithms supporting the functionality of the machine learning models, store alerts outputted by the system 100, store data shared by devices in the networks, store configuration information for the networks and/or devices of the system 100, store user profiles associated with the first and second users 101, 121, store device profiles associated with any device in the system 100, store communications traversing the system 100, store user preferences, store information associated with any device or signal in the system 100, store information relating to patterns of usage relating to the user devices, store any information obtained from any of the networks in the system 100, store historical data associated with the first and second users 101, 121, store device characteristics, store information relating to any devices associated with the first and second users 101, 121, store information associated with the communications network 135, store any information generated and/or processed by the system 100, store any of the information disclosed for any of the operations and functions disclosed for the system 100 herewith, store any information traversing the system 100, or any combination thereof. Furthermore, the database 155 may be configured to process queries sent to it by any device in the system 100.

Notably, as shown in FIG. 1, the system 100 may perform any of the operative functions disclosed herein by utilizing the processing capabilities of server 160, the storage capacity of the database 155, or any other component of the system 100 to perform the operative functions disclosed herein. The server 160 may include one or more processors 162 that may be configured to process any of the various functions of the system 100. The processors 162 may be software, hardware, or a combination of hardware and software. Additionally, the server 160 may also include a memory 161, which stores instructions that the processors 162 may execute to perform various operations of the system 100. For example, the server 160 may assist in processing loads handled by the various devices in the system 100, such as, but not limited to, receiving a request from an institution or borrower to determine an ability-to-pay for the borrower; accepting the request for determining the ability-to-pay for the borrower; obtaining data electronically by querying financial and/or other institutions and/or systems; computing a borrower's ability-to-pay score; classifying transactions (e.g., by type) associated with the borrower to assist in determining the borrower's ability-to-pay score; generating totals (i.e., value) for the classified transactions for time periods; adjusting totals for each transaction to the extent spending is discretionary; computing monthly (or other timeframe) adjusted residual income and income-expense ratio; excluding time periods that are not typical of the borrower's typical financial condition, behavior, and/or situation; averaging transaction values across the remaining time periods; computing weighted combinations of relevant cash flow and residual income indicators; synthesizing reports in a desired format that includes the computing relating to ability-to-pay; delivering the report to a requester of the ability-to pay score; and performing any other suitable operations conducted in the system 100 or otherwise. In certain embodiments, multiple servers 160 may be utilized to process the functions of the system 100. The server 160 and other devices in the system 100, may utilize the database 155 for storing data about the devices in the system 100 or any other information that is associated with the system 100. In one embodiment, multiple databases 155 may be utilized to store data in the system 100.

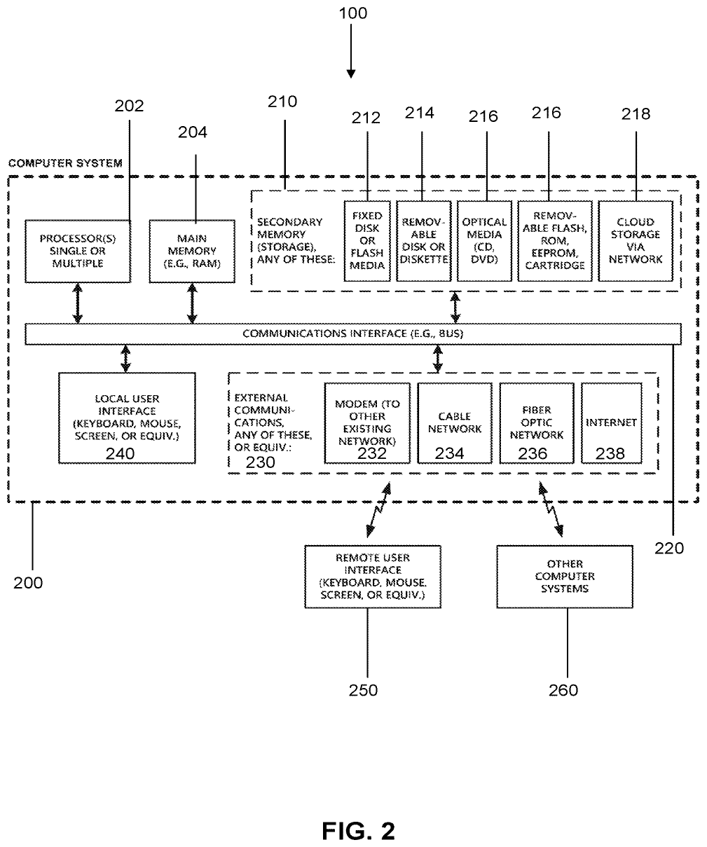

As would be appreciated by someone skilled in the relevant art(s) and described below with reference to FIG. 2, part or all of one or more aspects of the methods and apparatus discussed herein may be distributed as an article of manufacture that itself comprises a computer readable medium having computer readable code means embodied thereon.

The computer readable program code means is operable, in conjunction with a computer system, to carry out all or some of the steps to perform the methods or create the apparatuses discussed herein. The computer readable medium may be a recordable medium (e.g., hard drives, compact disks, EEPROMs, or memory cards). Any tangible medium known or developed that can store information suitable for use with a computer system may be used. The computer-readable code means is any mechanism for allowing a computer to read instructions and data, such as magnetic variations on a magnetic media or optical characteristic variations on the surface of a compact disk. The medium can be distributed on multiple physical devices (or over multiple networks). For example, one device could be a physical memory media associated with a terminal and another device could be a physical memory media associated with a processing center.

The computer systems and servers described herein each contain a memory that will configure associated processors to implement the methods, steps, and functions disclosed herein. Such methods, steps, and functions can be carried out, e.g., by processing capability on mobile device, POS terminal, payment processor, acquirer, issuer, or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor.

Aspects of the present disclosure shown in FIG. 2, or any part(s) or function(s) thereof, may be implemented using hardware, software modules, firmware, tangible computer readable media having instructions stored thereon, or a combination thereof and may be implemented in one or more computer systems or other processing systems.

FIG. 2 illustrates an example computer system 200 in which embodiments of the present disclosure, or portions thereof, may be implemented as computer-readable code. In certain embodiments, the computer system 200 can reside within system 100, be connected to system 100, be external to system 100, and/or be otherwise accessible by system 100. In certain embodiments, the computer system 200 may include one or more processors 202, a main memory 204, a secondary memory 210, a communication interface 220, a user interface 240, communications systems 230, remote user interfaces 250, other computing systems 260, any other components, or a combination thereof. For example, the various aspects of the user interfaces 240 depicted in FIG. 2 can be implemented in computer system using hardware, software, firmware, non-transitory computer readable media having instructions stored thereon, or a combination thereof and may be implemented in one or more computer systems or other processing systems. Hardware, software, or any combination of such may embody any of the modules and components used to implement the network, systems, methods and GU is described above with reference to FIGS. 1-3.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device 202 and a memory (e.g., main memory 204, secondary memory 210, etc.) may be used to implement the above-described embodiments. In certain embodiments, a processor device 202 may be a single processor, a plurality of processors, or combinations thereof. Processor devices may have one or more processor “cores.”

Various embodiments of the present disclosure are described in terms of this example computer system After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

In certain embodiments, the processor device 202 may be a special purpose or a general-purpose processor device. As will be appreciated by persons skilled in the relevant art, processor device 202 may also be a single processor in a multi-core/multiprocessor system, such system operating alone, or in a cluster of computing devices operating in a cluster or server farm. In certain embodiments, processor device 202 can connected to a communication infrastructure, for example, a bus, message queue, network, or multi-core message-passing scheme (e.g., communications interface 220).

The computer system 200 may also include a main memory 204, for example, random access memory (RAM), and may also include a secondary memory 210. In certain embodiments, the secondary memory 210 may include, for example, a hard disk drive (e.g., fixed disk or flash media drive 212), a removable storage drive 212, optical media 216 (e.g., compact disc, DVD, etc.), removable flash, ROM, EEPROM, and/or cartridge 216, cloud storage 218 (e.g., via a network), any other types of memory or storage, or a combination thereof. In certain embodiments, removable storage drive may comprise a floppy disk drive, a magnetic tape drive, an optical disk drive, a flash memory, or the like.

The removable storage drive 214 may read from and/or writes to a removable storage unit, such as in a well-known manner. The removable storage unit 214 may comprise a floppy disk, magnetic tape, optical disk, Universal Serial Bus (“USB”) drive, flash drive, memory stick, etc. which is read by and written to by removable storage drive. As will be appreciated by persons skilled in the relevant art, the removable storage unit 214 can include a non-transitory computer usable storage medium having stored therein computer software and/or data.

In certain implementations, the secondary memory 210 may include other similar means for allowing computer programs or other instructions to be loaded into the computer system 200. Such means may include, for example, a removable storage unit 214 and an interface. Examples of such means may include a program cartridge and cartridge interface (such as that found in video game devices), a removable memory chip (such as an EPROM, or PROM) and associated socket, and other removable storage units and interfaces which allow software and data to be transferred from the removable storage unit 214 to computer system 200.

The computer system 200 may also include a communications interface 220. In embodiments, communications interface devices can be implemented with the communications interface 220. The communications interface 220 may allow software and data to be transferred between the computer system 200 and external devices. The communications interface 220 may include a modem, a network interface (such as an Ethernet card), a communications port, a PCMCIA slot and card, or the like. Software and data transferred via the communications interface 220 may be in the form of signals, which may be electronic, electromagnetic, optical, or other signals capable of being received by communications interface 220. These signals may be provided to the communications interface via a communications path. The communications path carries signals and may be implemented using wire or cable, fiber optics, a phone line, a cellular/wireless phone link, an RF link or other communications channels.

In this document, the terms ‘computer readable storage medium, computer program medium, non-transitory computer readable medium,’ and ‘computer usable medium’ may be used to generally refer to tangible and non-transitory media such as removable storage unit, removable storage unit, and a hard disk installed in hard disk drive. Signals carried over the communications path can also embody the logic described herein. The computer readable storage medium, computer program medium, non-transitory computer readable medium, and computer usable medium can also refer to memories, such as main memory and secondary memory, which can be memory semiconductors (e.g., DRAMs, etc.). These computer program products are means for providing software to computer system.

Computer programs (also called computer control logic and software) are generally stored in a main memory 204 and/or secondary memory 210. The computer programs may also be received via a communications interface 220. Such computer programs, when executed, enable computer system 200 to become a specific purpose computer able to implement the present disclosure as discussed herein. In particular, the computer programs, when executed, enable the processor device to implement the processes of the present disclosure discussed below. Accordingly, such computer programs may represent controllers of the computer system 200. Where the present disclosure is implemented using software, the software may be stored in a computer program product and loaded into the computer system 200 using the removable storage drive 214, 216, interface, and hard disk drive, or communications interface 220.

In certain embodiments, the computer system 200 may include an external communications component 230, which may include a modem 232, a cable network 234, a fiber optic network 236, an internet 238, any other type of network, any other type of network device, any other type of communications components, or a combination thereof. In certain embodiments, the externa communications component 230 may be configured to enable the computer system 200 to communicate with external devices and/or systems. In certain embodiments, the communication interface 220 may be configured to interact with the external communications component 230 to relay data from the processor 202, the main memory 204, the secondary memory 210, and/or other components of the computer system 200 to external computer systems 260, remote user interfaces 250 (e.g., keyboards, computer mice, screens, etc.) and vice versa.

In certain embodiments, the computer system 200 can include a local user interface 240. In certain embodiments, the local user interface 240 may be any device, component, or system that may be configured to interact with the various components of the computer system 200 and may be configured to display data, content, and/or information. In certain embodiments, the local user interface 240 may be configured to receive inputs from a user, which may be utilized to control the various functionality and features of the computer system 200. In certain embodiments, for example, the local user interface may be, but is not limited to, a keyboard, a mouse, a screen or display, an input device, a controller, any type of interface, any type of user interface, or a combination thereof. In certain embodiments, the local user interface 240 can be configured to receive signals and/or instructions from the various components of the computer system 200 to render and display content and/or data, to perform various operations, or a combination thereof.

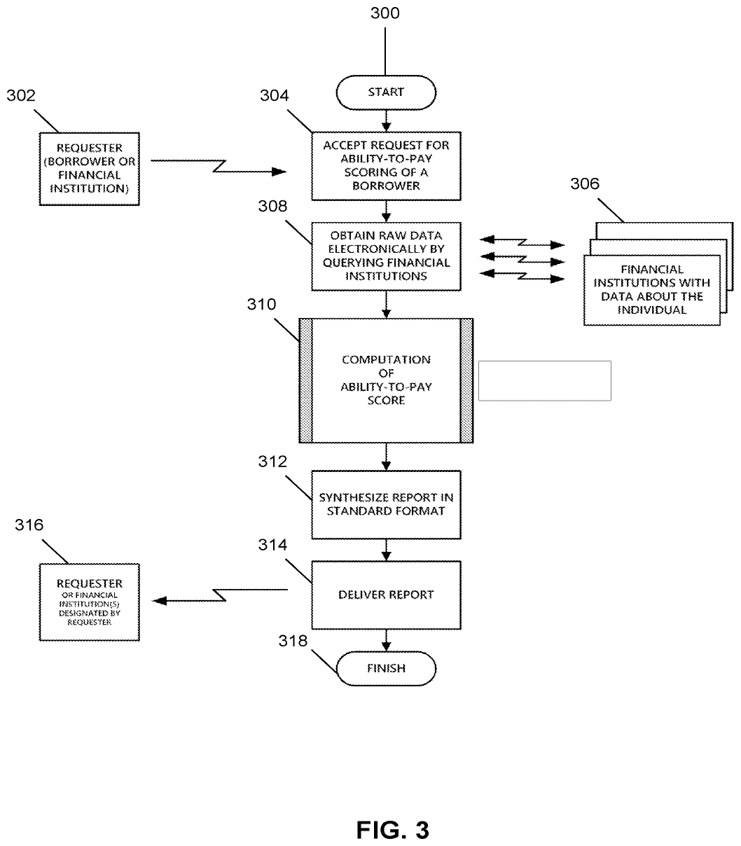

Referring now also to FIG. 3, an exemplary method 300 for determining an ability-to-repay obligations is illustrated. In certain embodiments, the method of FIG. 3 can be implemented in the systems 100, 200 of FIGS. 1-2 and 6 and/or any of the other systems, devices, and/or componentry illustrated in the Figures. In certain embodiments, the method of FIG. 3 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method of FIG. 3 can be performed at least in part by one or more processing devices (e.g., processor 102, processor 122, processor 141, processor 146, processor 151, and processor 161 of FIG. 1) and/or other devices, systems, components, or a combination thereof, of FIGS. 2 and 6. Although shown in a particular sequence or order, unless otherwise specified, the order of the operations in the method 300 can be modified and/or changed depending on implementation and objectives. Additionally, the method 400 can provide further detail relating to the computation of ability-to-pay score, as shown by step 310. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Generally, the method 300 provides a method of calculating an ability-to-pay score, and, in the process, calculate a cash flow index, adjusted cash flow index, available income, and adjusted available income. To that end, the method 300 obtains transactions from various data sources, such as a borrower's financial institutions. Such transactions may be associated with the borrower's checking accounts, savings accounts, credit cards, investment accounts, mortgage loans, car loans, any other financially-related accounts or products, or a combination thereof. The borrower may also supply the name of the borrower's employer, location, approximate monthly rent or mortgage payment amount (e.g., for matching to the obtained transactions associated with the borrower), electronic access to paystubs, any other supplemental data, or a combination thereof. In certain embodiments, the ability-to-pay score or index may be utilized to indicate the borrower's ability to pay and may be utilized to predict the borrower's risk of loan delinquency. In order to compute the foregoing, the borrower's income, outgo, adjusted outgo (i.e., the outgo if discretionary expenses are reduced by an amount), and residual (i.e., leftover after subtracting expenses) income with and without the adjustment. In certain embodiments, the method may be utilized to identify and confirm paychecks, rent payments, mortgage payments, utility payments, other periodic (e.g., monthly) payments, and then compute measures of month-to-month (or time period to time period) stability and account balance trends. In certain embodiments, the score may be scaled for a convenient range of values. For example, a median of 110 with an interquartile range of 20 may be utilized so that scores below 100 are in the lower quartile. In certain embodiments, scores below 80 or above 150 may be clamped at 80 and 150 respectively. In certain embodiments, the method 300 may calculate the scores without having to classify the borrower's transactions, such as by measuring income and outgo. In certain embodiments, the method 300 may include adjusting available income of the borrower by an offset (e.g., to test for ability to carry a heavier expense load) ahead of the scoring step(s). In certain embodiments, the method 300 may be utilized to cover nonlinear as well as linear functions and combinations.

At step 300, the method 300 may be started or initiated. In certain embodiments, the initiation of the method 300 may be performed and/or facilitated by utilizing the server 140, the server 145, the server 150, the server 160, the communications network 135, any component of the system 200, any combination thereof, or by utilizing any other appropriate program, network, system, or device. At step 302, the method 300 may include having a requester (e.g., borrower or financial institution) transmit a request to determine an ability-to-pay score of a borrower, such as first user 101. For example, the borrower may be a user that may be seeking to apply for a loan or other obligation and the requester may be seeking to determine the ability-to-pay score for the borrower to determine whether the borrower will be a reliable payor of the loan. In certain embodiments, the transmission of the request may be performed and/or facilitated by utilizing the server 140, the server 145, the server 150, the server 160, the communications network 135, any component of the system 200, any combination thereof, or by utilizing any other appropriate program, network, system, or device. At step 304, the method 300 may include accepting the request for determining the ability-to-pay scoring of the borrower. In certain embodiments, the accepting of the request may be performed and/or facilitated by utilizing the server 140, the server 145, the server 150, the server 160, the communications network 135, any component of the system 200, any combination thereof, or by utilizing any other appropriate program, network, system, or device.

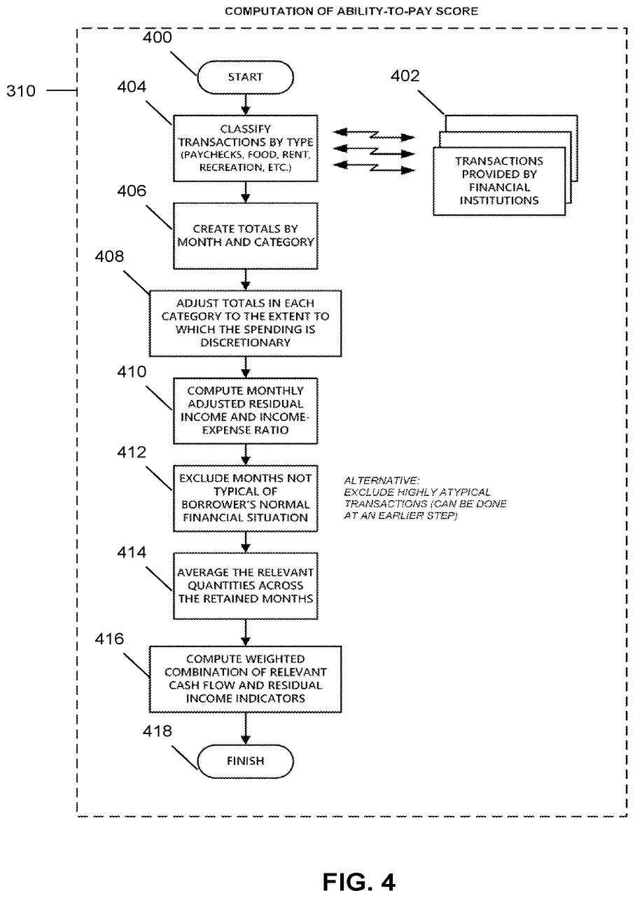

At step 306, financial institutions and/or other data sources may provide data associated with the borrower to the system 100. For example, the data may include, but is not limited to, financial transaction data over any number of periods of time (e.g., credits and debits to an account of the borrower over the course of months or years), demographic data (e.g., race, ethnicity, gender, etc.), psychographic data, personal data (e.g., age, height, family status, etc.), employment data (e.g., salary, employer name, years of experience, etc.), loan payment history, any other data associated with the user, or a combination thereof. At step 308, the method 300 may include obtaining the data electronically from the various data sources, such as by querying the data sources for the data associated with the borrower. In certain embodiments, the obtaining of the data may be performed and/or facilitated by utilizing the server 140, the server 145, the server 150, the server 160, the communications network 135, any component of the system 200, any combination thereof, or by utilizing any other appropriate program, network, system, or device. At step 310, the method 300 may include computing the borrower's ability-to-pay score, the details of which are further provided in FIG. 4. In certain embodiments, the ability-to-pay score may be performed and/or facilitated by utilizing the server 140, the server 145, the server 150, the server 160, the communications network 135, any component of the system 200, any combination thereof, or by utilizing any other appropriate program, network, system, or device.

Once the ability-to-pay score is calculated, the method 300 may include synthesizing a report in a standard format or specified format that includes the ability-to-pay score or index, an assessment of whether the borrower is a desirable candidate for a loan, or a combination thereof. In certain embodiments, the synthesizing of the report may be performed and/or facilitated by utilizing the server 140, the server 145, the server 150, the server 160, the communications network 135, any component of the system 200, any combination thereof, or by utilizing any other appropriate program, network, system, or device. At step 314, the method 300 may include delivering the report including the ability-to-pay score or index. In certain embodiments, at step 316, the report may be transmitted to the requester that requested the ability-to-pay score and/or assessment of the borrower. In certain embodiments, the transmission of the report may be performed and/or facilitated by utilizing the server 140, the server 145, the server 150, the server 160, the communications network 135, any component of the system 200, any combination thereof, or by utilizing any other appropriate program, network, system, or device. In certain embodiments, the method 300 may end at step 318.

In certain embodiments, the method 300 can be repeated as desired, which can be on a continuous basis, periodic basis, or at designated times. Notably, the method 300 can incorporate any of the other functionality as described herein and can be adapted to support the functionality of the system 100. In certain embodiments, functionality of the method 300 can be combined with other methods and/or functionality described in the present disclosure. In certain embodiments, certain portions of the method 300 can be replaced with other functionality of the present disclosure and the sequence of operations can be adjusted as desired.

Referring now also to FIG. 4, a method 400 providing further details relating to step 310 of the method 300 is shown. As with method 300, the method of FIG. 4 can be implemented in the systems 100, 200 of FIGS. 1-2 and 6 and/or any of the other systems, devices, and/or componentry illustrated in the Figures. In certain embodiments, the method of FIG. 4 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method of FIG. 4 can be performed at least in part by one or more processing devices (e.g., processor 102, processor 122, processor 141, processor 146, processor 151, and processor 161 of FIG. 1) and/or other devices, systems, components, or a combination thereof, of FIGS. 2 and 6. Although shown in a particular sequence or order, unless otherwise specified, the order of the operations in the method 400 can be modified and/or changed depending on implementation and objectives. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In certain embodiments, the method 400 can start at step 400, which may be once step 310 of the method 300 is reached. At step 402, the method 400 may include receiving transactions (e.g., financial) and/or other data associated with the borrower. In certain embodiments, the step 402 may correlate or be the same as step 306 of the method 300. In certain embodiments, the transaction and/or other data may be performed and/or facilitated by utilizing the server 140, the server 145, the server 150, the server 160, the communications network 135, any component of the system 200, any combination thereof, or by utilizing any other appropriate program, network, system, or device. In certain embodiments, once the transaction and/or other data associated with the borrower or received, the method 400 may proceed to step 404. At step 404, the method 400 may include classifying the transactions and/or other data by their type. For example, the transactions may be classified as paychecks, food expenses, rent expenses, recreation expenses, mortgage expenses, investment income, and the like. In certain embodiments, the transactions that are expenses may be classified as discretionary or non-discretionary. Discretionary expenses may be expenses that are not necessary and may be adjusted with greater latitude than a non-discretionary expense. Discretionary expenses may be necessary expenses and may be the type of expenses that is predictable and might not be able to be discounted or removed. In certain embodiments, the classification of the transactions may be skipped and may be an optional step. In certain embodiments, the classifying of the transactions may be performed and/or facilitated by utilizing the server 140, the server 145, the server 150, the server 160, the communications network 135, any component of the system 200, any combination thereof, or by utilizing any other appropriate program, network, system, or device.

At step 406, the method 400 may include calculating or creating totals for each time period (e.g., each month) and according to the category/classification. In certain embodiments, the calculating may be performed and/or facilitated by utilizing the server 140, the server 145, the server 150, the server 160, the communications network 135, any component of the system 200, any combination thereof, or by utilizing any other appropriate program, network, system, or device. At step 408, the method 400 may include adjusting the totals in each category to the extent to which the spending is discretionary. For example, entertainment discretionary expenses may be reduced by 70% and food-related discretionary expenses may be reduced by 15% because food items may be deemed to have a higher necessity than entertainment. The adjustment based on the type of discretionary expense may be modified as needed and/or based on its effectiveness in identifying borrower's ability to pay loans or other obligations. In certain embodiments, the adjusting of the totals may be performed and/or facilitated by utilizing the server 140, the server 145, the server 150, the server 160, the communications network 135, any component of the system 200, any combination thereof, or by utilizing any other appropriate program, network, system, or device. At step 410, the method 400 may include computing the monthly (or other time period) adjusted residual income and income-expense ratio (further details provided in the examples below). In certain embodiments, the computing of the monthly adjusted residual income and income-expense-ratio may be performed and/or facilitated by utilizing the server 140, the server 145, the server 150, the server 160, the communications network 135, any component of the system 200, any combination thereof, or by utilizing any other appropriate program, network, system, or device.

At step 412, the method 400 may include excluding time periods and corresponding transaction data (and/or other data) that are not typical of the borrower's typical spending, financial condition, habits, or a combination thereof. In certain embodiments, the excluding may be performed and/or facilitated by utilizing the server 140, the server 145, the server 150, the server 160, the communications network 135, any component of the system 200, any combination thereof, or by utilizing any other appropriate program, network, system, or device. At step 414, the method 400 may include averaging the relevant transaction values across the retained or remaining time periods. In certain embodiments, the averaging may be performed and/or facilitated by utilizing the server 140, the server 145, the server 150, the server 160, the communications network 135, any component of the system 200, any combination thereof, or by utilizing any other appropriate program, network, system, or device. At step 416, the method 400 may include computing the weighted combination of relevant cash flow and residual income indicators (further details provided in the examples below). In certain embodiments, the computing may be performed and/or facilitated by utilizing the server 140, the server 145, the server 150, the server 160, the communications network 135, any component of the system 200, any combination thereof, or by utilizing any other appropriate program, network, system, or device. The method 400 may then proceed to step 418, which may conclude method 400. Once at step 418, the method 400 may revert back to method 300 and may finalize the computation of the ability-to-pay score and proceed to step 312 to synthesize the report including the ability-to-pay score and/or a determined assessment of the potential of the borrower for a loan product.

In certain embodiments, the method 400 can be repeated as desired, which can be on a continuous basis, periodic basis, or at designated times. Notably, the method 400 can incorporate any of the other functionality as described herein and can be adapted to support the functionality of the system 100. In certain embodiments, functionality of the method 400 can be combined with other methods and/or functionality described in the present disclosure. In certain embodiments, certain portions of the method 400 can be replaced with other functionality.

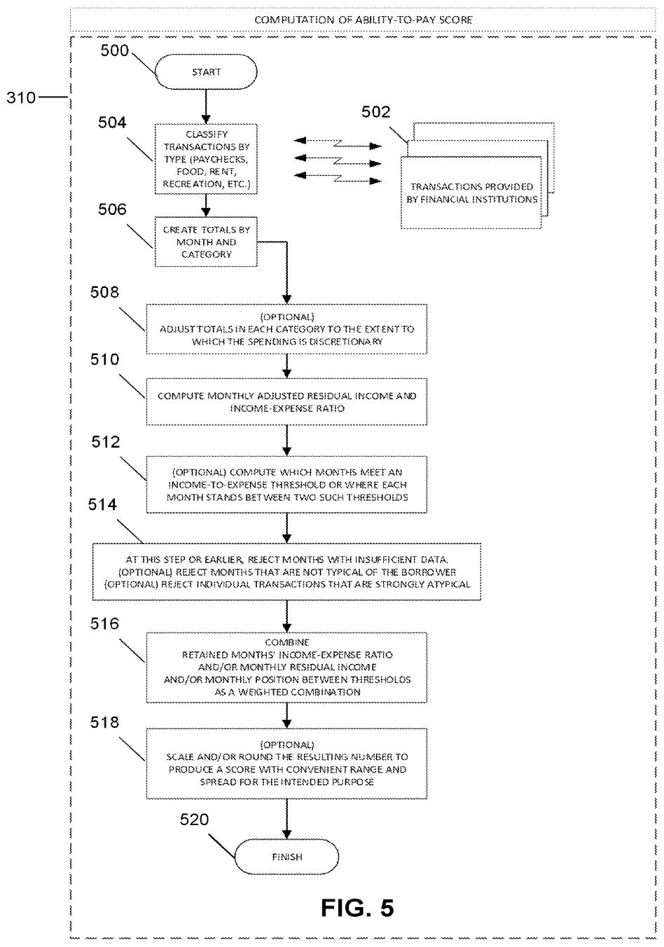

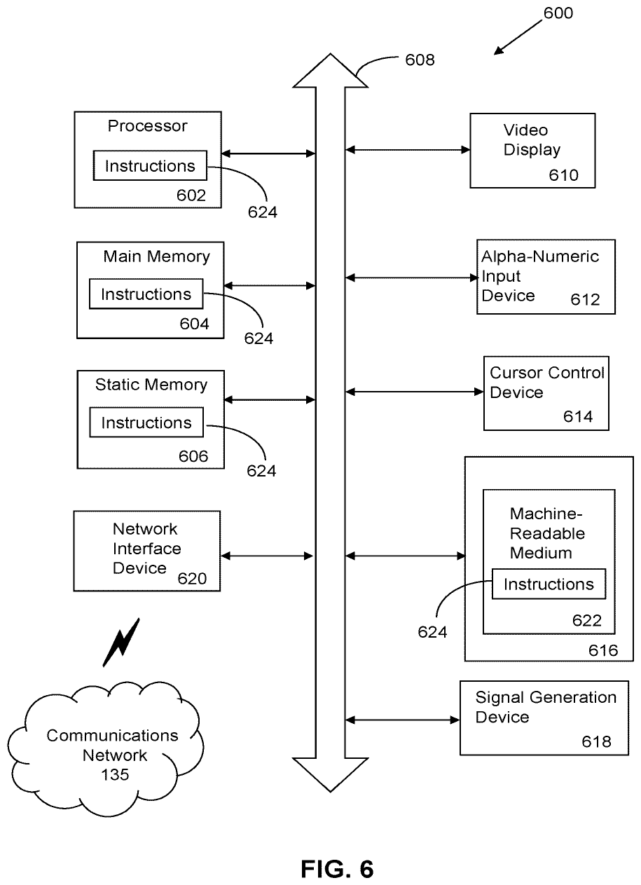

Referring now also to FIG. 5, an additional method 500 providing further details relating to step 310 of the method 300 is shown. As with method 300, the method of FIG. 5 can be implemented in the systems 100, 200 of FIGS. 1-2 and 6 and/or any of the other systems, devices, and/or componentry illustrated in the Figures. In certain embodiments, the method of FIG. 5 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method of FIG. 5 can be performed at least in part by one or more processing devices (e.g., processor 102, processor 122, processor 141, processor 146, processor 151, and processor 161 of FIG. 1) and/or other devices, systems, components, or a combination thereof, of FIGS. 2 and 6. Although shown in a particular sequence or order, unless otherwise specified, the order of the operations in the method 500 can be modified and/or changed depending on implementation and objectives. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In certain embodiments, the method 500 can start at step 500, which may be once step 310 of the method 300 is reached. At step 502, the method 500 may include receiving transactions (e.g., financial) and/or other data associated with the borrower. In certain embodiments, the step 502 may correlate or be the same as step 306 of the method 300. In certain embodiments, the transaction and/or other data may be performed and/or facilitated by utilizing the server 140, the server 145, the server 150, the server 160, the communications network 135, any component of the system 200, any combination thereof, or by utilizing any other appropriate program, network, system, or device. In certain embodiments, once the transaction and/or other data associated with the borrower or received, the method 500 may proceed to step 504. At step 504, the method 500 may include classifying the transactions and/or other data by their type. For example, the transactions may be classified as paychecks, food expenses, rent expenses, recreation expenses, mortgage expenses, investment income, and the like. In certain embodiments, the transactions that are expenses may be classified as discretionary or non-discretionary. Discretionary expenses may be expenses that are not necessary and may be adjusted with greater latitude than a non-discretionary expense. Discretionary expenses may be necessary expenses and may be the type of expenses that is predictable and might not be able to be discounted or removed. In certain embodiments, the classification of the transactions may be skipped and may be an optional step. In certain embodiments, the classifying of the transactions may be performed and/or facilitated by utilizing the server 140, the server 145, the server 150, the server 160, the communications network 135, any component of the system 200, any combination thereof, or by utilizing any other appropriate program, network, system, or device.

At step 506, the method 500 may include calculating or creating totals for each time period (e.g., each month) and according to the category/classification performed in step 504. In certain embodiments, the calculating may be performed and/or facilitated by utilizing the server 140, the server 145, the server 150, the server 160, the communications network 135, any component of the system 200, any combination thereof, or by utilizing any other appropriate program, network, system, or device. At step 508, which may be optional, the method 500 may include adjusting the totals in each category to the extent to which the spending is discretionary. For example, entertainment discretionary expenses may be reduced by 70% and food-related discretionary expenses may be reduced by 15% because food items may be deemed to have a higher necessity than entertainment. The adjustment based on the type of discretionary expense may be modified as needed and/or based on its effectiveness in identifying borrower's ability to pay loans or other obligations. In certain embodiments, the adjusting of the totals may be performed and/or facilitated by utilizing the server 140, the server 145, the server 150, the server 160, the communications network 135, any component of the system 200, any combination thereof, or by utilizing any other appropriate program, network, system, or device. At step 510, the method 500 may include computing the monthly (or other time period) adjusted residual income and income-expense ratio (further details provided in the examples below). In certain embodiments, the computing of the monthly adjusted residual income and income-expense-ratio may be performed and/or facilitated by utilizing the server 140, the server 145, the server 150, the server 160, the communications network 135, any component of the system 200, any combination thereof, or by utilizing any other appropriate program, network, system, or device.

At step 512, the method 500 may include computing which time periods satisfy or meet an income-to-expense threshold or where each time period stands between two such thresholds (e.g., within a range of thresholds). For example, at step 512, the method 500 may include computing which months meet a given income-to-expense threshold or whether a particular month slots between two threshold values. In certain embodiments, the computing may be performed and/or facilitated by utilizing the server 140, the server 145, the server 150, the server 160, the communications network 135, any component of the system 200, any combination thereof, or by utilizing any other appropriate program, network, system, or device. At step 514, which may be optional and may be performed earlier in the method 500, the method 500 may include excluding or rejecting time periods and corresponding transaction data (and/or other data) that are not typical of the borrower's typical spending, financial condition, habits, or a combination thereof. In certain embodiments, the excluding may be performed and/or facilitated by utilizing the server 140, the server 145, the server 150, the server 160, the communications network 135, any component of the system 200, any combination thereof, or by utilizing any other appropriate program, network, system, or device. At step 516, the method 500 may include combining the retained time periods' (e.g., months) income-expense ratio and/or time period residual income and/or time period position between thresholds as a weighted combination (example illustrated in the use-case scenarios described below). In certain embodiments, the combining may be performed and/or facilitated by utilizing the server 140, the server 145, the server 150, the server 160, the communications network 135, any component of the system 200, any combination thereof, or by utilizing any other appropriate program, network, system, or device. At step 518, the method 400 may include scaling and/or rounding the resulting number from step 516 to produce a score with a convenient range and spread for the intended purpose (e.g., to evaluate creditworthiness of a borrower applying for a loan or other obligation instrument). In certain embodiments, the scaling and/or rounding may be performed and/or facilitated by utilizing the server 140, the server 145, the server 150, the server 160, the communications network 135, any component of the system 200, any combination thereof, or by utilizing any other appropriate program, network, system, or device. The method 500 may then proceed to step 520, which may conclude method 500. Once at step 518, the method 500 may revert back to method 300 and may finalize the computation of the ability-to-pay score and proceed to step 312 to synthesize the report including the ability-to-pay score and/or a determined assessment of the potential of the borrower for a loan product.

In certain embodiments, the method 500 can be repeated as desired, which can be on a continuous basis, periodic basis, or at designated times. Notably, the method 500 can incorporate any of the other functionality as described herein and can be adapted to support the functionality of the system 100. In certain embodiments, functionality of the method 500 can be combined with other methods and/or functionality described in the present disclosure. In certain embodiments, certain portions of the method 500 can be replaced with other functionality.

In certain embodiments, the functionality of the systems 100, 200 and the methods 300, 400, 500 may be further explained via example use-case scenarios. In certain embodiments, the calculations and operations described below may be incorporated into the methods 300, 400, 500. As a first example, a borrower's transactions may be assumed to have already been grouped (e.g., into transactions to or from the same payee) and categorized (e.g., categorized as groceries, rent, entertainment, paychecks, etc.). For brevity, the example borrower in this example may only have 4 months of data, and only a few income and expense categories, however, any number of time periods and/or income and expense categories may be utilized.

Step 1. Calculate the total for the borrower's transactions by month and category, and compute the other totals, as shown here:

| Jun. 2021 | Jul. 2021 | Aug. 2021 | Sep. 2021 | |
|---|---|---|---|---|
| 3000.00 | 3200.00 | 3200.00 | 3200.00 | Income: Payroll |
| 0 | 5500.00 | 0 | 0 | Income: Unidentified |
| 3200.00 | 8700.00 | 3200.00 | 3200.00 | Total income |
| 1600.00 | 1600.00 | 1600.00 | 1600.00 | 1: xpenses: Rent |
| 983.00 | 860.00 | 1000.00 | 850.00 | Expenses: Groceries |
| 450.00 | 390.00 | 680.00 | 500.00 | Expenses: Entertainment |
| 3033.00 | 2850.00 | 3280.00 | 2950.00 | Total outgo |
| 6233.00 | 11,550.00 | 6480.00 | 6150.00 | Total Inoney handled |
| | | | | (incoirle plus expenses |
| | | | | as absolute values) |

Step 2. Adjust the expense categories by the extent to which they are discretionary. The extent to which each type of expense is discretionary may be a matter of empirical economics research. In this example, we may suppose that:
rent is 0% discretionary, groceries are 10% discretionary (because one can economize), and entertainment is 75% discretionary. As a result, the following subtractions may be made:
   O o from the rent,
   10⋅o from the groceries, and
   75% from the entertainment expenses,
yielding these:

| | | | | |
|---|---|---|---|---|
| 1600.00 | 1600.00 | 1600.00 | 1600.00 | ADJUSTED Exp.: Rent |
| 884.70 | 774.00 | 900.00 | 850.00 | ADJUSTED Exp.: Groceries |
| 112.50 | 97.50 | 170.00 | 125.00 | ADJUSTED Exp.: Entertainment |
| 2597.20 | 2471.5(} | 2670.00 | 2575.00 | ADJUSTED Total expenses |

Step 3. Compute adjusted residual income and adjusted income-expense ratio. The following quantities from the tables above may be utilized for convenience:

| Jun. 2021 | Jul. 2021 | Aug. 2021 | Sep. 2021 | |
|---|---|---|---|---|
| 3200.00 | 8700.00 | 3200.00 | 3200.00 | Total income |
| 2597.20 | 2471.50 | 2670.00 | 2575.00 | ADJIJ STED Total expenses |

Adjusted residual income may be total income minus adjusted total expenses.

| | | | | |
|---|---|---|---|---|
| 602.80 | 6228.50 | 530.00 | 625.00 | Adjusted residual income |

Adjusted income-expense ratio may be total income divided by adjusted total expenses,

| | | | | |
|---|---|---|---|---|
| 1.232 | 3.520 | 1.199 | 1.242 | Adjusted income-expense ratio |

Step 4. Reject unusable or misleading data.

In certain embodiments, such as by some reasonable criterion, eliminate months (or other time periods) for which data is insufficient (e.g., accounts missing, very small numbers of transactions in categories that should be numerous, etc.). That criterion may not eliminate anything from the data in this example.

Then, eliminate atypical months (or other time periods) and/or atypical transactions. For example, the foregoing can be performed in any of several ways:
Reject months in which one of the financial quantities (total money handled, total income, total expenses, residual income, etc.) is:
   Too far from the mean (e.g., beyond a desired deviation) of that quantity in all the months, measured as a fraction of the standard deviation (Covington's method O); or
   Too far from the median (e.g., beyond a desired deviation) of that quantity in all the months, measured as a fraction of the interquartile range (Covington's method 1); or
Reject months in which too large a proportion of the income or expenses are unidentified (method 2); or
Instead of rejecting months, reject highly atypical transactions themselves, in this case the $5500 unidentified income in July, and perform the calculation as if that transaction were not there (method 3).

Any reasonable application of any of these criteria may result in removing July 2021 or the $5500 transaction in that month.

Step 5. Average the relevant quantities across the retained months.

Assuming method 0, 1, or 2 has been used, and the whole month of July 2021 has been removed, it remains to average the total income, adjusted residual income, and adjusted income-expense ratio in the three remaining months:

| | | | | | |
|---|---|---|---|---|---|
| 3200.00 | 3200.00 | 3200.00 | [symbol] | 3200.00 | \,Jean total income |
| 602.80 | 530.00 | 625.00 | [symbol] | 585.93 | Mean adj residual inc. |
| 1.232 | 1.199 | 1-242 | [symbol] | 1.224 | Mean adj inc/exp ratio |

Other methods can include variations in which the median or some other measure of location is used in place of the mean.

Step 6. Combine the foregoing quantities (and possibly others averaged the same way) in a weighted way to produce an appropriately distributed index.

$$Compmc x = \begin{matrix}a \times mean total income + . \\ b \times mean adjusted residual income + \\ c \times mean adjusted income - expense ratio + \\ d\end{matrix}$$

\Vhcre dis a constant ofI.:; et.

The values of a, b, c, d (any of which may be zero) may be determined empirically by the implementor. In this worked example, let a=0.001, b=0.002, c=90, and d=−15.

Then this borrower's index (score) may be calculated as follows:

$$\begin{matrix}x 0 , 0 ( \} 1 \times 32 ( ) ( ) \cdot \{ \cdot ) \{ ) + 0.002 \times 585.93 + 90 \times 1.224 15 \\ 3.2 + 1.17 + 137.59 -- - 15 \\ 126.96\end{matrix}$$

Provided below is another exemplary use-case scenario for use with the systems 100, 200 and methods 300, 400, 500. Example 2:

This example may be utilized to illustrate the process of computing ability-to-pay indicators. The borrower's transactions may be assumed to have already been grouped (e.g., into transactions to or from the same payee) and categorized (groceries, rent, entertainment, paychecks, etc.).

In certain embodiments, the exemplary borrower in this example may have only 4 months of data, and only a few income and expense categories.

Step 1. Calculate the borrower's transactions by month and category, and compute the other totals, as shown below:

| Jun. 2021 | Jul. 2021 | Aug. 2021 | Sep. 2021 | |
|---|---|---|---|---|
| 3000.00 | 3200.00 | 3200.00 | 3200.00 | Income: Payroll |
| 0 | 5500.00 | 0 | 0 | Income: Unidentified |
| 3200.00 | 8700,00 | 3200,00 | 3200.00 | Total income |
| 1600.00 | 1600.00 | 1600.00 | 1600.00 | Expenses: Rent |
| 983,00 | 860.00 | 1000.00 | 850.00 | Expenses: Groceries |
| 450,00 | 390.00 | 680.00 | 500.00 | Expenses: Entertainment |
| 3033.00 | 2850.00 | 3280.00 | 2950.00 | Total outgo |
| 6233.00 | 11,550.00 | 6480.00 | 6150.00 | Total money handled |
| | | | | (irn.:: ome plus expenses |
| | | | | as absolute values) |

Step 2. Adjust the expense categories by the extent to which they are discretionary. The extent to which each type of expense is discretionary may be a matter of empirical economics research. In this worked example, it may be supposed that: rent is 0% discretionary, groceries are 10% discretionary (because one can economize), and entertainment is 75% discretionary. Based on the foregoing, the following may be subtracted from the discretionary expenses:
0% i from the rent,
Hr,; i from the groceries, and
75′Y; i from the entertainment expenses,
   yielding the following adjusted figures:

| | | | | |
|---|---|---|---|---|
| 1600.00 | 1600.00 | 1600.00 | 1600.00 | ADJUSTED Exp.: Rent |
| 884.70 | 774,00 | 900.00 | 850.00 | ADJUSTED Exp.: Groceries |
| 112.50 | 97,50 | 170.00 | 125.00 | ADJUSTED Exp.: Entertainment |
| 2597.20 | 2471.50 | 2670.00 | 2575.00 | ADJUSTED Total expenses |

Step 3. Compute adjusted residual income and adjusted income-expense ratio. The following quantities are provided from above, for convenience:

| Jun. 2021 | Jul. 2021 | Aug. 2021 | Sep. 2021 | |
|---|---|---|---|---|
| 3200.00 | 8700.00 | 3200.00 | 3200.00 | Total income |
| 2597.20 | 2471.50 | 2670.00 | 2575.00 | ADJUSTED Total expenses |

Adjusted residual income may be i<.ital income minus adjusted total expense.

| | | | | |
|---|---|---|---|---|
| 602.80 | 6228.50 | 530.00 | 625.00 | Adjusted residual income |

Adjusted income-expense ratio may be total income divided by a, tiusted total expenses.

| | | | | |
|---|---|---|---|---|
| 1.232 | 3.520 | 1.199 | 1.242 | Adjusted income-expense ratio |

Step 4. (Optional step) Threshold-based calculation.
Based on previously chosen thresholds for adjusted income-expense ratio, either:
Compute whether each month (or other time period) meets the threshold or not, assigning 1.0 for yes and 0.0 for no; or
Compute where each month (or other time period) stands on a scale between two thresholds, assigning 0 if below the lower threshold, 1 if above the upper threshold, and a continuous function from O to 1 for values in between.

In this example, two thresholds 0.9 and 1.3 may be utilized and the adjusted income-expense ratios may be mapped onto threshold scores with the function (x−0.9) I 0.4, clamped at 0 and 1. In practice a nonlinear function can be advantageous.

| | | | | |
|---|---|---|---|---|
| L232 | 3.520 | 1.199 | 1.242 | Adjusted income-expense ratio |
| 0.83 | LOO | 0.75 | 0.86 | Threshold score |

Step 5. Reject unusable or misleading data.

In certain embodiments, by some reasonable criterion, eliminate months for which data is insufficient (e.g., accounts missing, very small numbers of transactions in categories that should be numerous, etc.). That criterion may not eliminate anything from the data in this example.

Then, optionally, also eliminate atypical months and/or atypical transactions. The foregoing can be performed any of several ways:
Reject months in which one of the financial quantities (total money handled, total income, total expenses, residual income, etc.) is:
   Too far from the mean (e.g., beyond a standard deviation) of that quantity in all the months, measured as a fraction of the standard deviation (Covington's method 0); or
   Too far from the median (e.g., beyond a standard deviation) of that quantity in all the months, measured as a fraction of the interquartile range (Covington's method 1); or
Reject months in which too large a proportion of the income or expenses are unidentified (Sundstedt's method 2); or
Instead of rejecting months, reject highly atypical transactions themselves, in this case the $5500 unidentified income in July, and perform the calculation as if that transaction were not there (Sundstedt's method 3).

Any reasonable application of any of these criteria will throw out July 2021 or the $5500 transaction in it.

Step 5. Make a weighted combination of the relevant quantities across the retained months.

Assuming method 0, 1, or 2 has been used, and the whole month of July 2021 has been thrown out, it remains to average (or otherwise combine) the total income, adjusted residual income, adjusted income-expense ratio, and threshold score in the three remaining months. (Note: Some options in the next step do not need all four of the foregoing.)

| | | | | | |
|---|---|---|---|---|---|
| 3200.00 | 3200.00 | 3200.00 | [symbol] | 3200.00 | Mean total income |
| 602.80 | 530.00 | 625.00 | [symbol] | 585.93 | Mean adj resid inc |
| 1.232 | I.. 199 | 1.242 | [symbol] | 1.224 | Mean adj inc-exp |
| 0.83 | 0.75 | 0.86 | [symbol] | 0.81 | Threshold score |

(In certain embodiments, the median or some other measure of location may be used in place of the mean.)

Step 6. Combine the foregoing quantities (and possibly others averaged the same way) in a weighted way to produce an appropriately distributed index.

$$Compmc x = \begin{matrix}a \times mean total income + \\ bx mean adjusted residual income + \\ c ; \cdot ; mean a ( Unsted income - expense ratio + \\ d ' threshold sc . ore +\end{matrix} ,$$

vhere e .is a constant: offset

The values of a, b, c, d (any of which may be zero) may be determined empirically by the implementor. In this worked example, let a=0.001, b=0.001, c=30, d=50, and e=−15. Based on the foregoing, this borrower's index (score) may be calculated as:

$$\begin{matrix}( 1.001 \times 3200. + 0.001 \times 585.93 + 30 ; , ; : L 224 + SO \times 0.81 + - 15 \\ 3.2 , 0.59 + 36.7 , 40.5 , 15 \\ 96.\end{matrix}$$

Referring now also to FIG. 6, at least a portion of the methodologies and techniques described with respect to the exemplary embodiments of the systems 100, 200 and/or methods 300, 400, 500 can incorporate a machine, such as, but not limited to, computer system 600, or other computing device within which a set of instructions, when executed, can cause the machine to perform any one or more of the methodologies or functions discussed above. The machine can be configured to facilitate various operations conducted by the systems 100, 200. For example, the machine can be configured to, but is not limited to, assist the systems 100, 200 by providing processing power to assist with processing loads experienced in the systems 100, 200 by providing storage capacity for storing instructions or data traversing the system 100, or by assisting with any other operations conducted by or within the system 100. As another example, in certain embodiments, the computer system 600 can assist in performing any of the steps and/or operations of the methods 300, 400, 500 and/or performing any other operations of the systems 100, 200.

In some embodiments, the machine can operate as a standalone device. In some embodiments, the machine can be connected (e.g., using communications network 135, another network, or a combination thereof) to and assist with operations performed by other machines and systems, such as, but not limited to, the first user device 102, the second user device 122, the communications network 133, the communications network 135, the server 140, the server 145, the server 150, the server 160, edge devices 120, 132, the database 155, any other system, program, and/or device, or any combination thereof. The machine can be connected with any component in the system 100. In a networked deployment, the machine can operate in the capacity of a server or a client user machine in a server-client user network environment, or as a peer machine in a peer-to-peer (or distributed) network environment. The machine can comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 600 can include a processor 602 (e.g., a central processing unit (CPU), a graphics processing unit (GPU, or both), a main memory 604 and a static memory 606, which communicate with each other via a bus 508. The computer system 500 can further include a video display unit 610, which can be, but is not limited to, a liquid crystal display (LCD), a flat panel, a solid-state display, or a cathode ray tube (CRT). The computer system 600 can include an input device 612, such as, but not limited to, a keyboard, a cursor control device 614, such as, but not limited to, a mouse, a disk drive unit 616, a signal generation device 618, such as, but not limited to, a speaker or remote control, and a network interface device 620.

The disk drive unit 616 can include a machine-readable medium 622 on which is stored one or more sets of instructions 624, such as, but not limited to, software embodying any one or more of the methodologies or functions described herein, including those methods illustrated above. The instructions 624 can also reside, completely or at least partially, within the main memory 604, the static memory 606, or within the processor 602, or a combination thereof, during execution thereof by the computer system 600. The main memory 604 and the processor 602 also can constitute machine-readable media.

Dedicated hardware implementations including, but not limited to, application specific integrated circuits, programmable logic arrays and other hardware devices can likewise be constructed to implement the methods described herein. Applications that can include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 622 containing instructions 624 so that a device connected to the communications network 133, the communications network 135, another network, or a combination thereof, can send or receive voice, video or data, and communicate over the communications network 135, another network, or a combination thereof, using the instructions. The instructions 624 can further be transmitted or received over the communications network 133, the communications network 135, another network, or a combination thereof, via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” can be non-transitory, and, in certain embodiments, cannot include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements can be utilized and derived therefrom, such that structural and logical substitutions and changes can be made without departing from the scope of this disclosure. Figures are also merely representational and cannot be drawn to scale. Certain proportions thereof can be exaggerated, while others can be minimized. Accordingly, the specification and drawings are to be regarded in an illustrative rather than a restrictive sense.

Thus, although specific arrangements have been illustrated and described herein, it should be appreciated that any arrangement calculated to achieve the same purpose can be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure is not limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and can be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

What is claimed is:

1. A method for evaluating creditworthiness, the method comprising:
a. electronically receiving a query for a financial transaction between a borrower and a lender, wherein the financial transaction is a loan application;
b. aggregating a plurality of financial records, wherein the financial records are connected with the borrower, and the financial records include debits and credits;
c. classifying, by utilizing instructions from a memory that are executed by a processor, the debits into discretionary and non-discretionary expenses; and
d. scoring, by utilizing the instructions from the memory that are executed by the processor, the cash flow of the borrower based on the debits and credits, wherein the debits associated with discretionary expenses are given a discount value.

2. The method of claim 1, wherein non-discretionary expenses comprise rent payment history, mortgage payment history, utility payment history, or a combination thereof.

3. The method of claim 1, wherein non-discretionary expenses comprise mortgage loan obligations, car loan obligations, school loan obligations, or a combination thereof.

4. The method of claim 1, wherein the non-discretionary expenses are provided with an undiscounted value or weight.

5. The method of claim 1, wherein the cash flow is based on non-discretionary expenses.

6. The method of claim 1, wherein the aggregation of the plurality of financial transaction records comprises computer-executable instructions causing the processor to perform operations through one or more application programming interfaces (APis) provided by a financial institution computing system.

7. A method, comprising:
a. electronically receiving a query for a transaction between a borrower and a lender;
b. receiving a plurality of data associated with the borrower, wherein the data includes debits and credits;
c. classifying the debits as discretionary or non-discretionary expenses;
d. adjusting the discretionary expenses by an amount based on at least one type associated with the discretionary expenses to generate adjusted discretionary expenses;
e. computing, based on the adjusted discretionary expenses and the credits, an ability-to-pay score for the borrower;
f. synthesizing a report comprising the ability-to-pay score for the borrower; and
g. transmitting the report to the lender in response to the query.

8. The method of claim 7, further comprising classifying the debits and credits according to at least one debit type and at least one credit type respectively.

9. The method of claim 7, further comprising:
a. calculating a total amount of credits for each time period over a timeframe; and
b. calculating a total amount of debits for each time period over the timeframe based on the non-discretionary expenses and the adjusted discretionary expenses.

10. The method of claim 9, further comprising:
a. rejecting the total amount of credits for each time period for which information associated with the portion of the total amount of credits is insufficient, is atypical, or a combination thereof, thereby resulting in remaining total amount of credits for each remaining time period; and
b. rejecting the total amount of debits for each time period for which information associated with the portion of the total amount of debits is insufficient, is atypical, or a combination thereof, thereby resulting in remaining total amount of debits for each remaining time period.

11. The method of claim 10, further comprising:
a. calculating a mean total income for reach remaining time period based on the remaining total amount of credits for each remaining time period; and
b. calculating a mean adjusted residual income for each remaining time period, wherein the mean adjust residual income is calculated based on subtracting the remaining total amount of debits for each remaining time period from the remaining total amount of credits for each remaining time period to result in a residual income for each remaining time period and the averaging the residual income for each remaining time period.

12. The method of claim 11, further comprising:
a. calculating a mean adjusted residual income to expense ratio, wherein the mean adjusted residual income to expense ratio is calculated based on dividing the remaining total amount of credits for each remaining time period by the remaining total amount of debits for each remaining time period to result in a residual income to expense ratio for each remaining time period and averaging the residual income to expense ratio for each remaining time period; and
b. calculating a threshold score associated with the borrower for each remaining time period.

13. The method of claim 12, further comprising computing the ability-to-pay score based on the mean total income, the mean adjusted residual income, the mean adjusted income to expense ratio, the threshold score and an offset.

14. A system, comprising:
a. A memory that stores instructions; and
b. a processor that executes the instructions to configure the processor to:
I. electronically receive a query for a transaction between a borrower and a lender;
II. receive a plurality of data associated with the borrower, wherein the data includes debits and credits;
III. classify the debits as discretionary or non-discretionary expenses;
IV. adjust the discretionary expenses by an amount based on at least one type associated with the discretionary expenses to generate adjusted discretionary expenses;
V. compute, based on the adjusted discretionary expenses and the credits, an ability-to-pay score for the borrower;
VI. generate a report comprising the ability-to-pay score for the borrower; and
VII. provide the report to the lender in response to the query.

15. The system of claim 14, wherein the processor is further configured to:
a. calculate a total amount of credits for each time period over a timeframe; and
b. calculate a total amount of debits for each time period over the timeframe based on the non-discretionary expenses and the adjusted discretionary expenses.

16. The system of claim 15, wherein the processor is further configured to:
a. reject the total amount of credits for each time period for which information associated with the portion of the total amount of credits is insufficient, is atypical, or a combination thereof, thereby resulting in remaining total amount of credits for each remaining time period; and
b. reject the total amount of debits for each time period for which information associated with the portion of the total amount of debits is insufficient, is atypical, or a combination thereof, thereby resulting in remaining total amount of debits for each remaining time period.

17. The system of claim 16, wherein the processor is further configured to:
a. calculate a mean total income for reach remaining time period based on the remaining total amount of credits for each remaining time period; and
b. calculate a mean adjusted residual income for each remaining time period, wherein the mean adjust residual income is calculated based on subtracting the remaining total amount of debits for each remaining time period from the remaining total amount of credits for each remaining time period to result in a residual income for each remaining time period and the averaging the residual income for each remaining time period.

18. The system of claim 17, wherein the processor is further configured to:
a. calculate a mean adjusted residual income to expense ratio, wherein the mean adjusted residual income to expense ratio is calculated based on dividing the remaining total amount of credits for each remaining time period by the remaining total amount of debits for each remaining time period to result in a residual income to expense ratio for each remaining time period and averaging the residual income to expense ratio for each remaining time period; and
b. calculate a threshold score associated with the borrower for each remaining time period.

19. The system of claim 18, wherein the processor is further configured to compute the ability-to-pay score based on the mean total income, the mean adjusted residual income, the mean adjusted income to expense ratio, the threshold score and an offset.

20. The system of claim 14, wherein the processor is further configured to determine whether the borrower is suitable for the transaction based on the ability-to-pay score.
